(19) United States
(12) Patent Application Publication
(10) Pub. No.: US 2025/0322409 A1
(43) Pub. Date: Oct. 16, 2025

(54) SYSTEMS AND METHODS TO GENERATE SUGGESTED RESPONSES TO CUSTOMER INQUIRIES FOR CUSTOMER RELATIONSHIP MANAGEMENT

(71) Applicant: Zendesk, Inc., San Francisco, CA (US)

(72) Inventors: Mariana Sá Correia Leite de ALMEIDA, Lisbon (PT); David Oliveira APARÍCIO, Porto (PT); Samuel David Pelaio ARCADINHO, Lisbon (PT); Ricardo Silva BARATA, Lisbon (PT); Pedro COELHO, Lisbon (PT); Cristina FONSECA, Lisbon (PT); Pawel GOCEK, Gliwice (PL); Jakub KONIK, Kraków (PL); Ceslovas LOPAN, Charlottenlund (DK); Ricardo Manuel Paula MARTINS, Tavira (PT); Pedro MATOS GERALDES MONTEIRO, Lisbon (PT); Nuno Filipe Mateus NOGUEIRA, Lisbon (PT); David António Dias VIEGAS, Lisbon (PT)

(21) Appl. No.: 19/175,731

(22) Filed: Apr. 10, 2025

Related U.S. Application Data
(60) Provisional application No. 63/633,008, filed on Apr. 11, 2024.

(51) Int. Cl. G06Q 30/015; G06F 9/451

(52) U.S. Cl. CPC G06Q 30/015; G06F 9/451

(57) ABSTRACT

The present disclosure relates to generating suggested responses to customer requests using machine learning models. In one example, a method includes: receiving, from a customer, a customer request via a communication channel; displaying in a customer support user interface the customer request; processing the customer request with a machine learning model to determine a suggested response to the customer request; and displaying in an agent assistance user interface element in the customer support user interface: the suggested response to the customer request; a first user interface element configured to implement the suggested response; and a second user interface element configured to dismiss or modify the suggested response.

### CROSS-REFERENCE TO RELATED APPLICATIONS

This Application claims the benefit of and priority to U.S. Provisional Patent Application No. 63/633,008, filed on Apr. 11, 2024, the entire contents of which are hereby incorporated by reference.

### BACKGROUND

### Field

Aspects of the present disclosure relate to generating suggested responses to customer requests using machine learning models.

### Description of Related Art

Numerous types of organizations offer end user support in which, for example, an end user has an issue or a request and reports it to a support service of the organization (including a number of support service agents) using a communication channel, such as email or chat. These requests (also referred to as “tickets”) can relate to a myriad of issues, such as help with a login, obtaining information regarding an order, deleting an account, etc. Preparing proper responses to such tickets is a main responsibility for the support service agents of these organizations.

Having properly trained support service agents is helpful for providing the proper responses to the tickets. However, hiring, training, and retaining these support service agents is an expensive task that requires a lot of time and resources.

In an effort to reduce the time and resources required for responding to the tickets, various techniques exist for the problem of preparing proper responses to such tickets. One solution is to prepare a set of pre-defined responses to sample support tickets and to have the support service agents or a “bot” respond to the tickets with one or more of the pre-defined responses. While this solution provides some pre-defined responses in order to expedite the process of providing proper responses to the tickets, this solution has several issues. For example, if a ticket does not correspond to any of the sample support tickets, the support service agents or the bot would not be able to use any of the pre-defined responses to respond to the ticket because the pre-defined responses would not be responsive to the ticket.

Accordingly, there is a need for improved techniques for preparing proper responses to tickets.

### SUMMARY

One aspect provides a method, comprising: receiving, from a customer, a customer request via a communication channel; displaying in a customer support user interface the customer request; processing the customer request with a first machine learning model to determine a suggested response to the customer request; and displaying in an agent assistance user interface element in the customer support user interface: the suggested response to the customer request; a first user interface element configured to implement the suggested response; and a second user interface element configured to dismiss or modify the suggested response.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system architecture for generating suggested responses to customer requests using a machine learning model.

FIG. 2 depicts an example process flow for generating suggested responses to customer requests using a machine learning model.

FIG. 3 depicts an example data structure for representing a plurality of parameters associated with a prompt to a machine learning model for generating suggested responses to customer requests using a machine learning model.

FIG. 4 depicts an example illustration related to a plurality of available actions for a machine learning model to choose from for generating suggested responses to customer requests using a machine learning model.

FIG. 5 depicts another example illustration related to a plurality of available actions for a machine learning model to choose from for generating suggested responses to customer requests using a machine learning model.

FIG. 6 depicts an example illustration of a customer support user interface that interacts with a system for generating suggested responses to customer requests using a machine learning model.

FIG. 7 depicts an example process flow for generating suggested responses to customer requests using machine learning models.

FIG. 8 depicts an example method of generating suggested responses to customer requests using a machine learning model.

FIG. 9 depicts another example method of generating suggested responses to customer requests using a machine learning model.

FIG. 10 depicts an example method of generating suggested responses to customer requests using machine learning models.

FIG. 11 depicts an example processing environment in which a system for generating suggested responses to customer requests using a machine learning model may be implemented.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable media for generating suggested responses to customer requests (also referred to herein as “tickets” or “support tickets”) using machine learning models.

Aspects described herein relate to a customer support system, such as a customer relationship management system, that interacts with at least one machine learning model to generate suggested responses to customer requests or inquiries. The customer support system is configured to receive as input a customer request which is provided to the machine learning model. The machine learning model may be configured to generate the suggested responses to the customer requests based on pre-defined data such as, for example, a prompt and a set of available actions that the machine learning model can take. The machine learning model automatically generates the suggested responses to the customer requests and provides them to the customer support system. The customer support system provides these suggested responses to a live customer support agent (also referred to herein as “agent” or “operator”) to approve, edit, or dismiss before an authorized response is provided to the customer. This customer support system therefore combines the best qualities of both machine learning models (which can automatically generate desired information, such as suggested responses to customer requests, resulting in, e.g., reduced delays in the responses to the customer requests being provided) and systems operated by well-trained customer support agents who can review and approve the automatically generated suggested responses from the machine learning model before being implemented. Beneficially, the customer support system results in, for example, improved responses (e.g., having increased relevance and accuracy) to the customer requests delivered more quickly. The customer support system thus saves a considerable amount of time and resources that would otherwise be required to hire, train, and retain live customer support agents. Beneficially then, the number of required customer support agents may be reduced while the accuracy and relevance of the responses provided to the customers for various types of customer requests may be maintained or improved.

In order to generate the suggested responses via the machine learning model, the customer support system may provide to the machine learning model, for example, an intended purpose for the machine learning model, a format of response to be provided by the machine learning model, and/or a set of rules associated with a response to be provided by the machine learning model. Further, the machine learning model may be provided with a list of available actions that the machine learning model is allowed to take. The customer support system can then provide the customer request to the machine learning model, which can then automatically generate the suggested responses based on the “boundaries” defined for the machine learning model, including, for example, the rules associated with the response to be provided by the machine learning model. The suggested responses generated by the machine learning model can then be provided to a live customer support agent via a user interface to, for example, approve, edit, or dismiss (e.g., via corresponding user interface elements). In some aspects, approval of a suggested response or an edited suggested response may cause an action to be taken by the customer support system, such as cancelling an order, issuing a refund, or the like.

Beneficially, aspects described herein may also process the suggested responses generated by the machine learning model (e.g., a first machine learning model) with a second machine learning model in order to determine whether to provide the suggested responses to the customer support agents to, for example, approve or edit. That is, the second machine learning model may be trained to determine whether any suggested responses from the first machine learning model should be presented to a customer service agent for consideration. Accordingly, the solutions described herein may further improve the suggested responses generated by a machine learning model by providing a more efficient solution that utilizes a second machine learning model to reduce the number of suggested responses that are edited or dismissed by a customer service agent. By utilizing one or more machine learning models along with input from live customer support agents, the best qualities of the machine learning models and systems operated by the live customer support agents are combined in the solution described herein to provide technical improvements (with respect to, e.g., delay and accuracy) in responding to customer requests.

### Example System Architecture

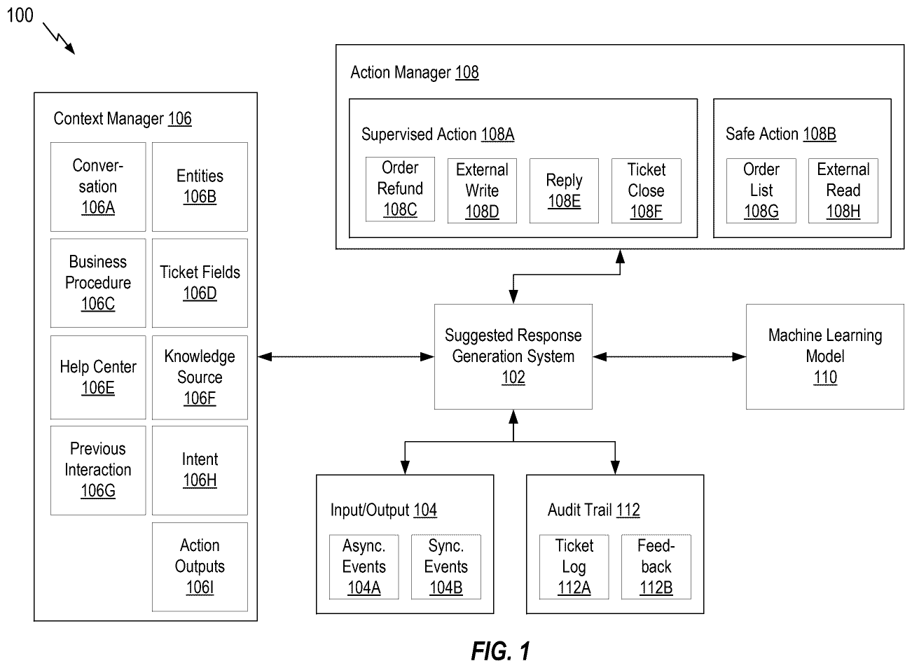

FIG. 1 depicts an example system architecture 100 for generating suggested responses to customer requests using a machine learning model. As shown, the example system architecture 100 includes a suggested response generation system 102 that is in data communication with an input/output (I/O) module 104, a context manager 106, an action manager 108, a machine learning model 110, and an audit trail module 112. The suggested response generation system 102 may be in data communication with one or more of the other systems or modules via, for example, a communication bus, a network interface equipment, or the like.

The suggested response generation system 102 may be a computing system configured to generate suggested responses to customer requests utilizing the techniques described herein. While the suggested response generation system 102 and other portions of the example system architecture 100 are illustrated as separate systems, modules, or components in FIG. 1, the example system architecture 100 may be implemented as a system on one or more computing devices within a local network (e.g., a local area network (LAN)) or a distributed system on a plurality of computing devices on multiple networks in data communication with one another (e.g., a wide area network (WAN), Internet, or the like).

The I/O module 104 includes an asynchronous events component 104A (e.g., an email events component) and a synchronous events component 104B (e.g., an online chat events component) in this example. The I/O module 104 may receive one or more asynchronous events (e.g., one or more emails) via the asynchronous events component 104A and/or one or more synchronous events (e.g., one or more online chats) from a customer (or a user device thereof) and provide them to the suggested response generation system 102 via a communication channel. For example, the I/O module 104 may receive information corresponding to a customer request as an email, an online chat, a fillable web form, or a transcript of a phone conversation. Moreover, the I/O module 104 may receive one or more asynchronous events and/or one or more synchronous events from the suggested response generation system 102 and provide them to the customer or the user device thereof. For example, the I/O module 104 may receive a request for more information or a response to the customer request from the suggested response generation system 102 and provide them to the customer or the user device thereof via the communication channel.

The context manager 106 may be a system or a module that is configured to manage one or more components relating to the context of a customer request. In this example, the context manager 106 includes: a conversation component 106A, an entities component 106B, a business procedure component 106C, a ticket fields component 106D, a help center component 106E, a knowledge source component 106F, a previous interaction component 106G, an intent component 106H, and an action outputs component 106I. In various aspects, the context manager 106 may be configured to store and maintain information useful for generating the suggested responses to customer requests by the suggested response generation system 102. That is, the context manager 106 may be accessed by the suggested response generation system 102 to utilize the information provided via the conversation component 106A (e.g., relating to current exchange of information between a customer and the suggested response generation system 102 such as a current series of emails and/or online chats), the entities component 106B (e.g., relating to the entities related to responding to customer requests such as an organization providing a product or a service related to the customer requests), the business procedure component 106C (e.g., relating to one or more procedures including various sets of steps for an operator to follow in order to fulfill customer requests such as requesting the customer's information, requesting the product or service identity related to the customer requests, requesting information regarding what the customer would like to achieve, or the like), the ticket fields component 106D (e.g., relating to various fields of a ticket such as date, time, customer name or account, or the like), the help center component 106E (e.g., relating to help center articles on customer-facing tasks, such as how to delete a user account), the knowledge source component 106F (e.g., relating to internal information source available to an organization), the previous interaction component 106G (e.g., relating to historical data of communication between customers and the suggested response generation system 102 such as past emails or online chats), the intent component 106H (e.g., relating to information such as an objective or a purpose related to what a customer may be requesting to achieve in a customer request such as a request to cancel an order, to issue a refund, change account information, or the like), and/or the action outputs component 106I (e.g., relating to data corresponding to outputs based on various actions implemented for responding to customer requests). Other component(s) may also be possible, and the context manager 106 may not be limited to just the components 106A-I described herein.

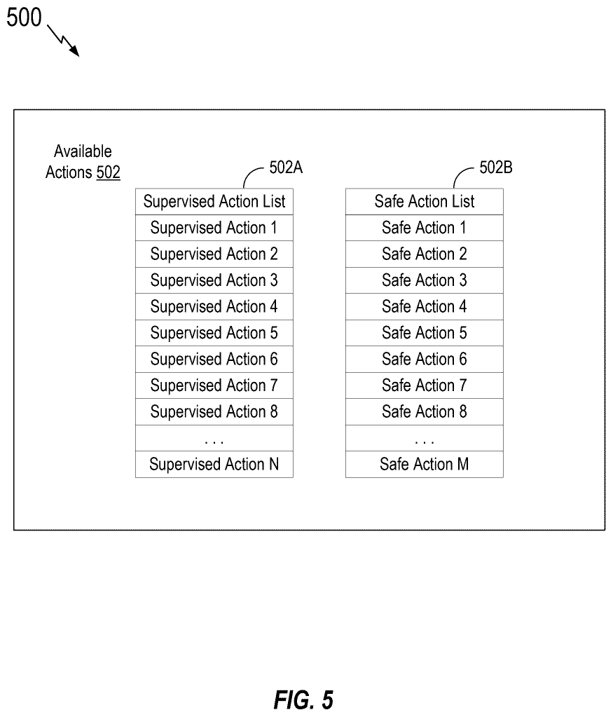

The action manager 108 may receive an instruction to perform one or more actions from the suggested response generation system 102 and provide data responsive to such instruction (e.g., a confirmation or acknowledgment responsive to the instruction once the instruction has been fulfilled). The action manager 108 may include a supervised action component 108A and a safe action component 108B. In various aspects, the supervised action component 108A may control one or more actions that are supervised and performed based on, for example, an approval of a live customer support agent. As described further herein (e.g., with reference to FIG. 5), some examples of the supervised actions may include: refunding orders (e.g., controlled by an order refund controller 108C), performing an external write to an external system element (e.g., controlled by an external write controller 108D), sending a reply to a customer request (e.g., controlled by a reply controller 108E), and/or closing a ticket (e.g., controlled by a ticket close controller 108F).

The safe action component 108B may control one or more actions that are performed without any approval of a live customer support agent. As also described further herein (e.g., with reference to FIG. 5), some examples of the safe actions include: listing orders (e.g., controlled by an order list controller 108G) and performing an external read from an external system element (e.g., controlled by an external read controller 108H).

The machine learning model 110 may be or include a model that can process various types of input (e.g., from the I/O module 104, the context manager 106, and/or the action manager 108, as well as an end user such as a customer providing a customer request), including a large language model (LLM). The machine learning model 110 may be an off-the-shelf machine learning model, such as an off-the-shelf LLM or, optionally, a fine-tuned machine learning model that has been trained to generate suggested responses to customer requests (e.g., a fine-tuned LLM). When an LLM is used, the LLM may be or incorporate, among other information, a prompt to be utilized to generate the suggested responses. In some examples, the machine learning model 110 may be or include a machine learning system or module that includes a plurality of machine learning models. In various aspects, the suggested responses may include information intended for the end user such as the customer providing a customer request and/or an action to be taken by a customer support agent or a customer support system for fulfilling the customer request. For example, the suggested responses may be or include text suggested to be provided to the end user as a response to the customer request, a recommended action to be taken by the customer support agent or the customer support system, such as cancelling an order, updating an account, or the like, etc.

The audit trail module 112 may include a service that manages or tracks ticket log 112A (e.g., corresponding to the history of events associated with a ticket) and feedback information 112B as used by the techniques described herein.

### Example Process Flow

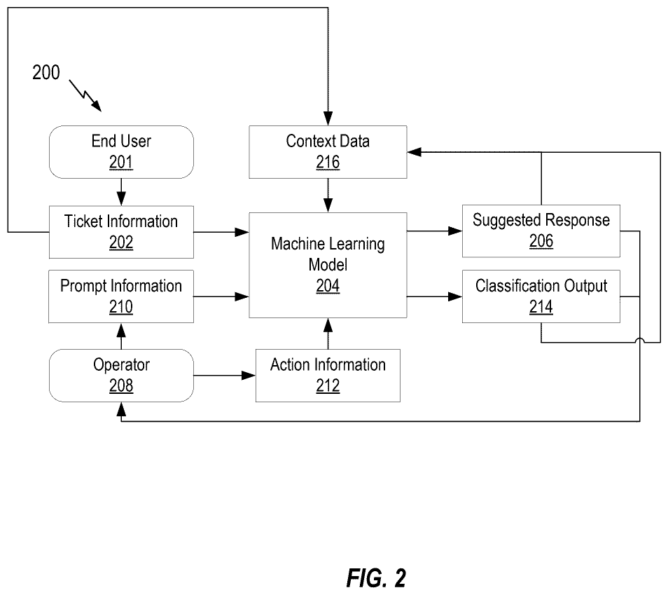

FIG. 2 depicts an example process flow 200 for generating suggested responses to customer requests using a machine learning model.

In various aspects, the example process flow 200 may begin with an end user 201 providing some ticket information 202. In some aspects, the machine learning model 204 (which may be similar to the machine learning model 110 of FIG. 1) may receive prompt information 210 and action information 212 prior to receiving the ticket information 202 from the end user 201. The prompt information 210 and the action information 212 may be provided by an operator 208 of, for example, an organization providing a customer relationship management system or tool that utilizes the machine learning model 204 to provide a suggested response 206 responsive to the ticket information 202. The prompt information 210 and the action information 212 may define, for example, the “boundaries” within which the machine learning model 204 may generate the suggested response 206. In some examples, the operator 208 may be or include a live customer support agent. In some aspects, the operator 208 and the live customer support agent may be different entities. Additionally, the machine learning model 204 may generate classification output 214, which may be provided to the operator 208. For example, the classification output 214 may include information related to an intent and/or a procedure associated with a customer request. That is, the machine learning model 204 may receive the ticket information 202 and identify the relevant intent and/or the relevant procedure from the ticket information 202. The intent may be information related to what the end user 201 is requesting to achieve (e.g., as described in the ticket information 202), and the procedure may be information related to one or more steps to be followed by the operator 208 and/or a customer support system in order to fulfill the customer request based on the ticket information 202. In various aspects, the suggested response 206 and the classification output 214 may be added to context data 216 which may be provided as an additional input to the machine learning model 204 for generating the suggested response 206, for example, in subsequent iterations of processing customer requests. That is, the interaction involving the ticket information 202, the identified intent and/or procedure from the classification output 214, the suggested response 206 generated based on the ticket information 202 and the identified intent and/or procedure (and authorized by the operator 208), and other relevant information may be added to the context data 216 which can be used, for example, for generating the suggested response 206 in the subsequent iterations of processing the customer requests. For example, the context data 216 can be used for generating the suggested response 206 in the subsequent iterations when the ticket information 202 included in the subsequent customer requests may include information that results in similar or the same intent and/or procedure being identified.

In various aspects, the suggested response 206 provided to the operator 208 may be, for example, in the form of a user interface element, such as a part of a user interface displayed to the operator 208. For example, the suggested response 206 may include text provided to the operator 208 (e.g., provided along with a soft button on a user interface that corresponds to an action to be implemented if the operator 208 executes the soft button). The text may include information regarding the customer request found in the ticket information 202 (e.g., “Thank you for the information. I've found your order #26262 placed on the 29th of December 2023, with a total amount of $97.99. Would you like to cancel the entire order or just certain items?”). The soft button may be a user interface element configured to cause the text to be sent to the end user 201 if selected. The text may be provided with one or more additional soft buttons such as, for example, one configured to, if selected, populate the user interface with another user interface element for editing the text (e.g., to be edited by a live customer support agent). In some examples, the suggested response 206 may include, additionally or alternatively, other types of data such as image or audio (e.g., corresponding to how the customer request may be resolved) that may be helpful for providing a relevant response to the customer request.

The classification output 214 may also be used to include an alert or a notice on a user interface that may notify the operator 208 that the machine learning model 204 has detected some information about the ticket information 202—such as, for example, an intent or a procedure associated with the ticket information 202. In various examples, the intent may correspond to what the ticket information 202 is about—such as, for example, order cancellation, account update, or the like. The procedure may correspond to one or more specific steps or rules associated with fulfilling a customer request included in the ticket information 202—such as, for example, whether the customer needs to be authenticated, what type of orders may be cancelled, what information in an account may be modified, what details are needed to fulfill the customer request, how to fulfill the customer request, or the like.

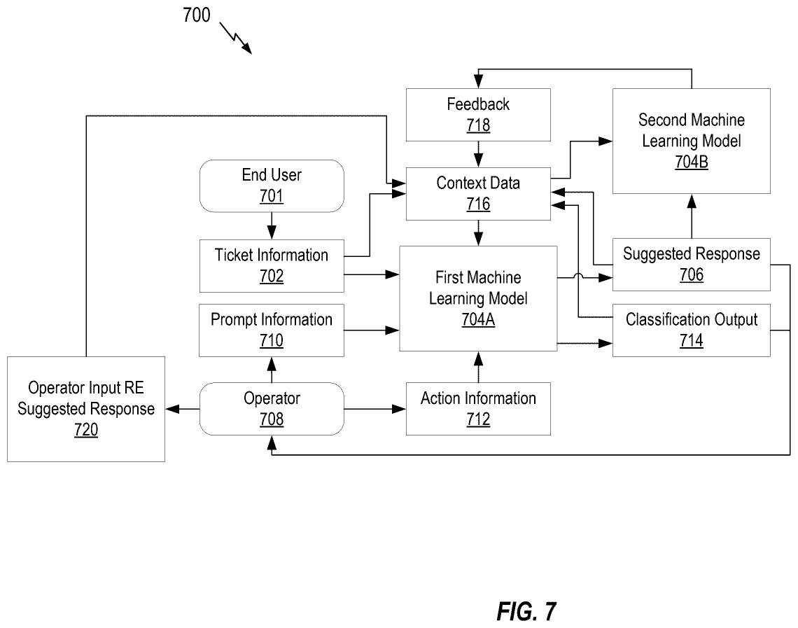

As shown, the suggested response 206 and the classification output 214, as well as the ticket information 202, may be processed by the machine learning model 204 as part of the context data 216 provided to the machine learning model 204 as an input. In various aspects, the context data 216 may include the suggested response 206 and the classification output 214 received from the machine learning model 204 as well as the corresponding ticket information 202 to be processed as part of, for example, historical data that may be utilized by the machine learning model 204 for generating the suggested response 206 in subsequent iterations of customer request processing. The classification output 214 may include the predicted intent and/or the relevant steps of a procedure that provide relevant context information to the machine learning model 204. Further, how the suggested response 206 is used by the operator 208 with respect to the ticket information 202—for example, whether the suggested response 206 was accepted, modified, or dismissed—may provide further context or history for the machine learning model 204 to utilize for generating the suggested response 206. Such historical data may be used, for example, for an offline training or evaluation process of the machine learning model 204. In some aspects, the offline training or evaluation process of the machine learning model 204 may include determining a performance metric associated with the suggested response 206. Accordingly, as further disclosed herein (e.g., with reference to FIG. 7), the operator action related to the suggested response 206 for a given customer request may be fed back to the machine learning model 204 as part of the context data 216 as an input.

In various aspects, the context data 216 may further include one or more of, for example, earlier and current conversations and interactions between live customer support agents and customers, relevant parties or entities, information from various request or ticket fields, relevant intent and procedure data, other knowledge sources, etc.

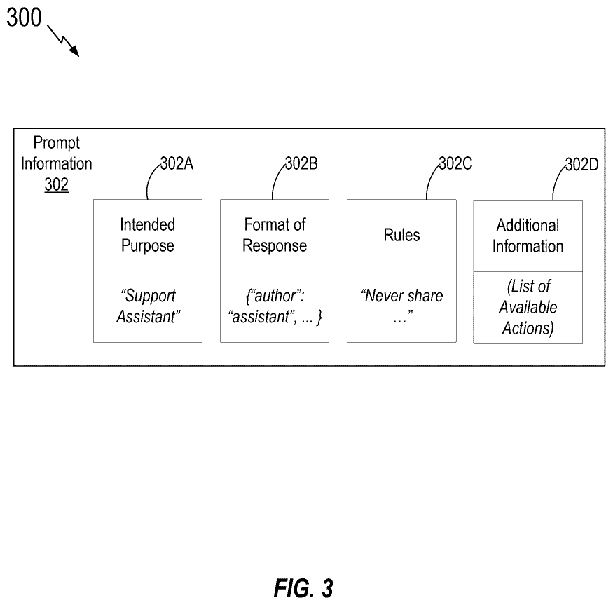

In various aspects, the prompt information 210 can be engineered to improve the performance of the machine learning model 204 as measured by, for example, how often the suggested response 206 is approved for implementation. Additional details regarding the prompt information 210 are disclosed herein with reference to FIG. 3.

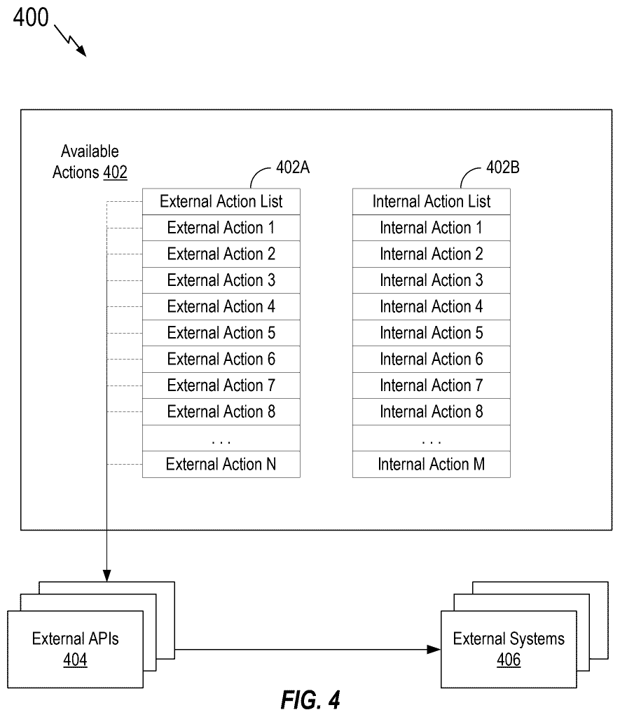

In various aspects, the action information 212 may include a list of available actions for the machine learning model 204 and define what action(s) the machine learning model 204 can implement in addition to or in association with the suggested response. Additional details regarding the action information 212 are disclosed herein with reference to FIGS. 4 and 5.

### Example Data Structure for Prompt Information

FIG. 3 depicts an example data structure 300 for representing a plurality of parameters associated with a prompt to a machine learning model. In various aspects, prompt information 302 (corresponding to the prompt information 210 of FIG. 2) may include a plurality of fields corresponding to, for example, an intended purpose 302A for the machine learning model, a format of response 302B to be provided by the machine learning model, and/or one or more rules 302C associated with a response to be provided by the machine learning model. For example, the prompt information 302 may be provided to the machine learning model in the form of a prompt (e.g., to an LLM), a set of instructions, etc. In some examples, it may be possible that a suggested response or action does not have any relevant parameter.

The intended purpose 302A may define the role of the machine learning model. As but one example, the intended purpose 302A may be provided to the machine learning model as follows: “You are a support assistant, and you will be resolving customer requests. You can also talk to your supervisor in case any help is needed. Supervisor may reach out to you as well with questions or request.” The intended purpose 302A may also indicate which source of information may be utilized by the machine learning model, for example, as follows: “Consult the list of procedures to know how to resolve the customer request.”

Further, the format of response 302B may include one or more parameters such as, for example, author, recipient, and content to be provided within the response from the machine learning model. For example, the format of response 302B may be defined and provided to the machine learning model, as follows:

This format will be used for communication:
′′′
{‘author’: string, \\ can be one of the following: customer, assistant,
supervisor
‘recipient’: string, \\ can be one of the following: customer, assistant,
supervisor
“content”: string \\ content of the suggested message}
′′′

Moreover, the one or more rules 302C may include information regarding, for example, what the machine learning model can and cannot provide in its response. For example, the one or more rules 302C may be provided to the machine learning model as follows:
As an assistant, your task is to respond to each received message individually. For every message you receive, provide only a single json object in your reply, not more. Example of response: “‘{‘author’: ‘assistant’, ‘recipient’: ‘customer’, ‘content’: ‘Hi, how can I help you?’}’” Never share object identifiers directly with customers as this information is not going to be relevant for them. Don't use double quotes inside your json fields. Remember, never assume any preferences or choices by a customer. Always ask for relevant information and don't come up with any data by yourself, such as customer email address or order number. Always ask customer or supervisor to provide required data or use data provided by relevant functions. Don't answer questions for which you do not find a relevant procedure.

In some examples, one or more examples corresponding to these fields may also be provided to the machine learning model as part of the prompt information 302. In various aspects, the information corresponding to the prompt information 302 may be provided to the machine learning model in, for example, a natural language form when the machine learning model includes, for example, an LLM. As an example, the following may be provided to the machine learning model:
If your procedures only contain steps to resolve customer requests for cancelling orders and deleting accounts and a customer asks for information regarding tracking their order, you should say “Sorry, but that question is outside of my area of expertise.”

Moreover, the prompt information 302 may also include additional information 302D. For example, a list of actions described herein with reference to, for example, FIGS. 4 and 5, may be included as part of the additional information 302D of the prompt information 302 provided to the machine learning model.

### Example List of Available Actions for Machine Learning Models

FIG. 4 depicts an example illustration 400 related to a plurality of available actions 402 for a machine learning model to choose from to provide as a suggested response to customer requests. The available actions 402 may correspond to at least a portion of the action information 212 of FIG. 2 that is provided to the machine learning model 204 for generating the suggested response 206. In various aspects, the list of available actions may correspond to, for example, one or more external actions 402A and/or one or more internal actions 402B. The one or more external actions 402A are implemented by one or more Application Programming Interfaces (APIs) 404 for one or more external systems 406 or services (where the one or more APIs 404 may thus be referred to as external APIs). The one or more internal actions 402B are implemented without requiring any API for an external service. For example, the external actions 402A may be implemented by the APIs corresponding to looking up an order, cancelling an order, or issuing a refund for an order. An example of the internal actions 402B may be to send a message.

FIG. 5 depicts another example illustration 500 related to a plurality of available actions 502 for a machine learning model to choose from to suggest for responding to customer requests. The available actions 502 may correspond to at least a portion of the action information 212 of FIG. 2 that is provided to the machine learning model 204 for generating the suggested response 206.

In various aspects, the list of available actions 502 may correspond to one or more supervised actions 502A that require an operator approval to be implemented and/or one or more safe actions 502B that do not require the operator approval to be implemented. For example, the supervised actions 502A may include those that correspond to an execution that affects a customer or an organization such as, for example, initiating a refund for an order, sending a reply, closing a ticket, or the like, or those that modifies information such as, for example, a write action that modifies information regarding an account, an order, or the like. A request for approval may be provided to the operator (e.g., as a user interface element) for these actions, such that these actions would be implemented when (e.g., only when) the operator approves them. The user interface element for providing the operator's approval may be a soft button labeled, for example, “Approve,” “Accept,” or “Send.” Examples of safe actions 502B include those that correspond to an action that does not modify any customer information, such as, for example, providing existing information to a customer by accessing the existing information from, for example, a source of information such as a memory or a storage device. In various aspects, the information corresponding to the available actions 502 (as well as the available actions 402 of FIG. 4) may be provided to the machine learning model in, for example, a natural language form when the machine learning model includes, for example, an LLM.

### Example Customer Support User Interface (UI) Environment

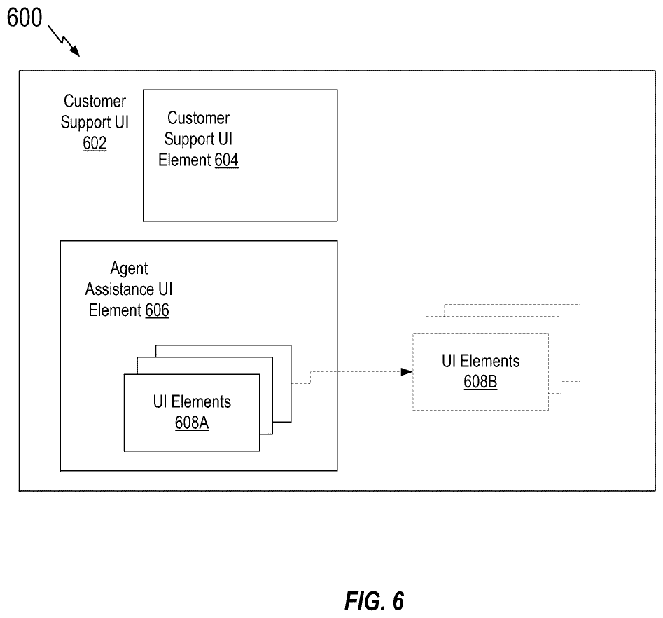

FIG. 6 depicts an example 600 of a customer support UI 602 that interacts with a system for generating suggested responses to customer requests using a machine learning model. In various aspects, the customer support UI 602 may include at least a customer support UI element 604. Further, the customer support UI 602 may include an agent assistance UI element 606 which includes one or more UI elements 608A. In some aspects, the selection of one or more of the UI elements 608A may generate one or more additional UI elements 608B that are related to the selected ones of the UI elements 608A and populate at least a portion of the customer support UI 602.

In various aspects, the customer support UI 602 may be a UI that is provided on an output device such as a display of a user device such as, for example, a computer, a mobile phone, or the like.

In various aspects, the customer support UI element 604 provides the means for a customer support agent to monitor the interaction with a customer or a customer request or ticket. For example, the customer support UI element 604 may display an exchange between a customer and the customer support agent, including a ticket information (such as, e.g., the content of the ticket information 202 of FIG. 2), which may be provided to a machine learning model to provide a suggested response, as disclosed herein. Moreover, the customer support UI element 604 may display content corresponding to one or more actions from the customer support agent to enable the customer support agent to be able to monitor the progress of processing the customer support request.

At least one of the UI elements 608A may include a UI element for displaying the suggested response generated by the machine learning model. Another one or more of the UI elements 608A may provide the means for the customer support agent to initiate an action regarding the suggested response generated by the machine learning model. For example, one of these UI elements 608A may be a soft button that is configured to, when selected, implement the suggested response. When selected, this element may send the suggested response to the customer, initiate an action to address or fulfill the customer request for, for example, executing or cancelling an order, modifying an account, or the like. Another one of these UI elements 608A may be a soft button that is configured to, when selected, allow the customer support agent to modify the suggested response generated by the machine learning model. In that regard, when this element is selected, one of the additional UI elements 608B may be populated on the customer support UI 602 that allows the customer support agent to modify the suggested response (e.g., the text included in the suggested response, the action associated with the suggested response, the parameters associated the action, etc.). Yet another one of these UI elements 608A may be a soft button that is configured to, when selected, dismiss the suggested response without implementing the suggested response. That is, the customer support agent may select this UI element if the agent determines that the suggested response is not to be implemented due to, for example, being irrelevant, inaccurate, etc. In some examples, when the customer support agent selects to dismiss the suggested response, another UI element (e.g., including a set of selectable elements) may be provided to inquire about the customer support agent to provide specific feedback regarding why the suggested response was not accepted (e.g., where the set of selectable elements may correspond to reasons such as “because the action parameters are incorrect,” “the message does not follow the steps outlined in a procedure,” etc.).

In various examples, the agent assistance UI element 606 may provide one or more of the UI elements 608A described herein. Further, the UI elements 608A provided by the agent assistance UI element 606 may include various possible combinations of the UI elements 608A described herein.

In some aspects, at least one of the UI elements 608A may be configured as an inquiry UI element in which a customer support agent can initiate an inquiry to a machine learning model. For example, the customer support agent may input an inquiry via one of the UI elements 608A (e.g., the inquiry UI element). The inquiry from the customer support agent may then be provided to and processed by the machine learning model to determine a response to the inquiry. Then, the response from the machine learning model may be provided to the customer support agent via the inquiry UI element. In certain aspects, one of the UI elements 608A may be configured to, when selected, implement one or more of the additional UI elements 608B configured as the inquiry UI element(s).

### Example Process Flow for Generating Suggested Responses

FIG. 7 depicts an example process flow 700 for generating suggested responses to customer requests using machine learning models.

As similarly disclosed herein with reference to FIG. 2, in various aspects, the example process flow 700 may begin with an end user 701 providing some ticket information 702. In some aspects, a first machine learning model 704A may receive prompt information 710 and action information 712 prior to receiving the ticket information 702 from the end user 701. The prompt information 710 and the action information 712 may be provided by an operator 708 of, for example, a customer relationship management or support system or tool that utilizes the first machine learning model 704A to provide a suggested response 706 responsive to the ticket information 702. As described herein, the prompt information 710 and the action information 712 may define, for example, the “boundaries” within which the first machine learning model 704A is to be configured to generate the suggested response 706. In some examples, the operator 708 may be or include a live customer support agent. In some aspects, the operator 708 and the live customer support agent may be different entities. Additionally, the first machine learning model 704A may generate classification output 714, which may be provided to the operator 708. As similarly described herein with reference to FIG. 2, in various aspects, the suggested response 706 and the classification output 714, as well as the ticket information 702, may be added to context data 716 which may be provided as an additional input to the first machine learning model 704A for generating the suggested response 706. The context data 716 may be used as part of an in-context learning for the first machine learning model 704A.

Furthermore, in the example depicted in FIG. 7, a second machine learning model 704B receives the suggested response 706 from the first machine learning model 704A and outputs information to be utilized by the first machine learning model 704A for subsequent generation of suggested responses to customer requests. As shown, the second machine learning model 704B also receives the context data 716 as input for generating the information to provide to the first machine learning model 704A. In certain aspects, an operator input 720 regarding a suggested response (as received via, e.g., one or more UI elements 608A described herein with reference to FIG. 6) may be added to the context data 716.

The second machine learning model 704B may be an off-the-shelf LLM or a model trained to output information that is relevant for the first machine learning model 704A to improve its response. In that regard, the second machine learning model 704B may output, for example, an error report regarding an unacceptable suggested response generated by the first machine learning model 704A. For example, the second machine learning model 704B may detect that a response from the first machine learning model 704A is unacceptable based on detecting: a step being missed from a procedure related to resolving a customer request, some context information not being considered in the procedure, part of the response being irrelevant with respect to a given conversation between the customer and the customer support agent associated with the response, not all rules being followed (such as due to sensitive information that should not be disclosed being output to a user interface), etc. The output of the second machine learning model 704B (such as, for example, a number, a classification class, or an error report related to a suggested response) may be provided to the first machine learning model 704A as part of its context to be utilized for subsequent generation of suggested responses. Furthermore, the output of the second machine learning model 704B may be used as offline training data to improve the first machine learning model 704A, such that similar errors may be avoided in subsequent iterations.

In various aspects, one or more portions of the context data 716 may be provided to the second machine learning model 704B, such that the second machine learning model 704B may generate and output information based on the specific one or more portion(s) of the context data 716 utilized as input. For example, the second machine learning model 704B may receive only the suggested response 706 and relevant procedure data of the context data 716 to generate, as output, a report regarding whether the suggested response 706 generated by the first machine learning model 704A is in accordance with the relevant procedure including, for example, a plurality of steps related to a sequential set of answers (such as customer information, order number, or the like) to be requested from the end user 701 in order to fulfill a customer request (e.g., regarding whether a procedure step may have been skipped or some procedure steps may have been performed out of order in generating the suggested response 706, or the like). In another example, the second machine learning model 704B may receive only the suggested response 706 and data related to the operator input 720 regarding the suggested response 706 (e.g., but without the relevant procedure data). The report output from the second machine learning model 704B in this example may then be related to whether the suggested response 706 was acceptable to the operator 708 for implementation without any modification. These are example scenarios only, and other scenarios involving different portions of the context data 716 being received by the second machine learning model 704B and different outputs being generated by the second machine learning model 704B are possible. In some aspects, the output from the second machine learning model 704B regarding the suggested response 706 may be provided as feedback data 718 and added to the context data 716 to be utilized by, for example, an offline training of the first machine learning model 704A for generating the suggested response 706 in subsequent iterations of processing the customer requests. The second machine learning model 704B may be, for example, prompted, trained, or fine-tuned to evaluate the performance of the first machine learning model 704A based on the context data 716. A response generated by the first machine learning model 704A that may be associated with one or more errors (e.g., in the procedure followed, context considered, etc.) may be used as a negative sample, and a response generated by the first machine learning model 704A that is not associated with any error may be used as a positive sample. The goal of the first machine learning model 704A may be to generate responses that the second machine learning model 704B does not evaluate as being erroneous.

### Example Methods of Generating Suggested Responses to Customer Requests

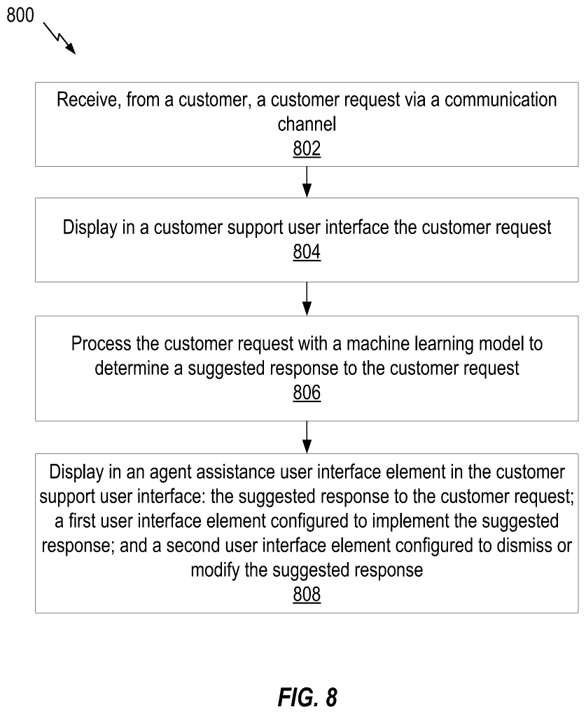

FIG. 8 depicts an example method 800 of generating suggested responses to customer requests using a machine learning model.

Step 802 includes receiving, from a customer, a customer request via a communication channel. As disclosed herein, the customer request may be received via, for example, an email or an online chat.

Step 804 includes displaying in a customer support UI (such as, e.g., the customer support UI 602 described herein with reference to FIG. 6) the customer request.

Step 806 includes processing the customer request with a machine learning model to determine a suggested response to the customer request. In some aspects, processing the customer request with the machine learning model may include providing a prompt to the machine learning model, providing data corresponding to a list of available actions for the machine learning model to choose from, providing the customer request to the machine learning model, receiving first classification output corresponding to an intent associated with the customer request and second classification output corresponding to a procedure associated with the customer request, and receiving the suggested response to the customer request. As disclosed herein, the prompt may include: first information related to an intended purpose for the machine learning model, second information related to a format of response to be provided by the machine learning model, and third information related to one or more rules associated with a response to be provided by the machine learning model. Each available action of the list of available actions may include one or more parameters related to each available action. Moreover, the intent associated with the customer request may include fourth information related to what the customer is requesting to achieve in the customer request, and the procedure associated with the customer request may include fifth information related to one or more steps to follow in order to fulfill the customer request. In certain aspects, the method 800 may also include implementing the one or more steps corresponding to the procedure based on the intent associated with the customer request.

As also disclosed herein, at least a first one of the list of available actions may include an external action that is implemented by an API for an external service, and at least a second one of the list of available actions may include an internal action that is implemented without an API for an external service. Moreover, the list of available actions may include one or more supervised actions that require an operator approval to be implemented and/or one or more safe actions that do not require the operator approval to be implemented. In certain aspects, the method 800 may also include receiving a selection of the first user interface element, and implementing the suggested response by executing at least one of: one or more external actions each implemented by an API for an external service or one or more internal actions implemented without an API for an external service. In some examples, implementing the suggested response may include sending a response to the customer request via the communication channel. In certain examples, implementing the suggested response may include taking an action to modify an account associated with the customer.

Step 808 includes displaying in an agent assistance UI element in the customer support UI (e.g., the agent assistance UI element 606 in the customer support UI 602 described herein with reference to FIG. 6): the suggested response to the customer request, a first user interface element configured to implement the suggested response, and a second user interface element configured to dismiss or modify the suggested response. For example, the first user interface element and the second user interface element may be provided as the UI elements 608A in the agent assistance UI element 606 as described herein with reference to FIG. 6. In some aspects, the method 800 may also include receiving a selection of the second user interface element, and dismissing the suggested response. In certain aspects, the method 800 may also include receiving a selection of the second user interface element, and displaying in the customer support user interface an editor user interface element comprising: a third user interface element configured to receive an input to edit the suggested response, a fourth user interface element configured to implement the edited suggested response, and a fifth user interface element configured to cancel editing the suggested response.

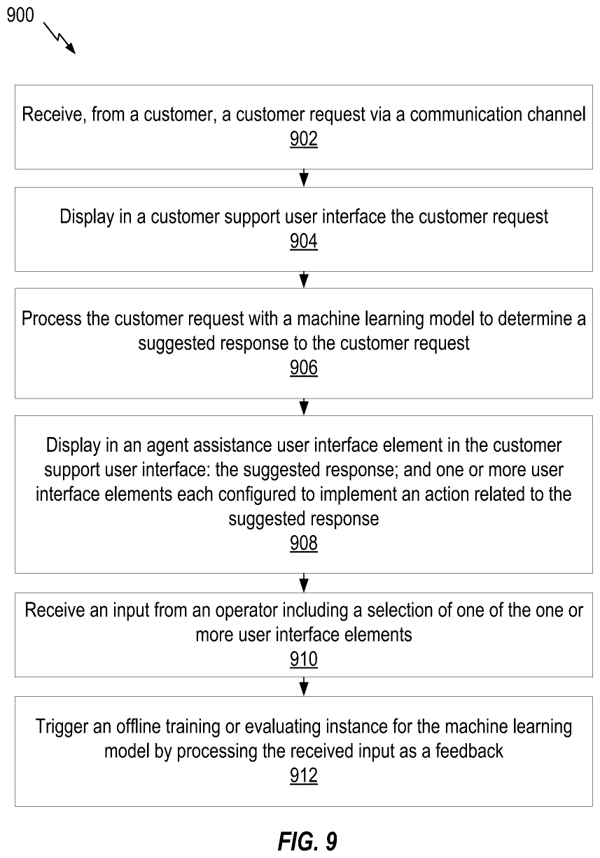

FIG. 9 depicts another example method 900 of generating suggested responses to customer requests using a machine learning model.

Step 902 includes receiving, from a customer, a customer request via a communication channel (such as, e.g., an email or an online chat as described herein).

Step 904 includes displaying in a customer support user interface (such as, e.g., the customer support UI 602 described herein with reference to FIG. 6) the customer request.

Step 906 includes processing the customer request with a machine learning model to determine a suggested response to the customer request.

Step 908 includes displaying in an agent assistance user interface element in the customer support user interface (e.g., the agent assistance UI element 606 in the customer support UI 602 described herein with reference to FIG. 6): the suggested response, and one or more user interface elements (such as, e.g., the UI elements 608A described herein with reference to FIG. 6) each configured to implement an action related to the suggested response.

Step 910 includes receiving an input from an operator including a selection of one of the one or more user interface elements. For example, the input from the operator may be received via a soft button on a user interface to cause a corresponding action (such as, e.g., sending a reply to the customer, cancelling an order, updating an account, or the like) to be implemented.

Step 912 includes triggering an offline training or evaluating instance for the machine learning model by processing the received input as a feedback for the machine learning model.

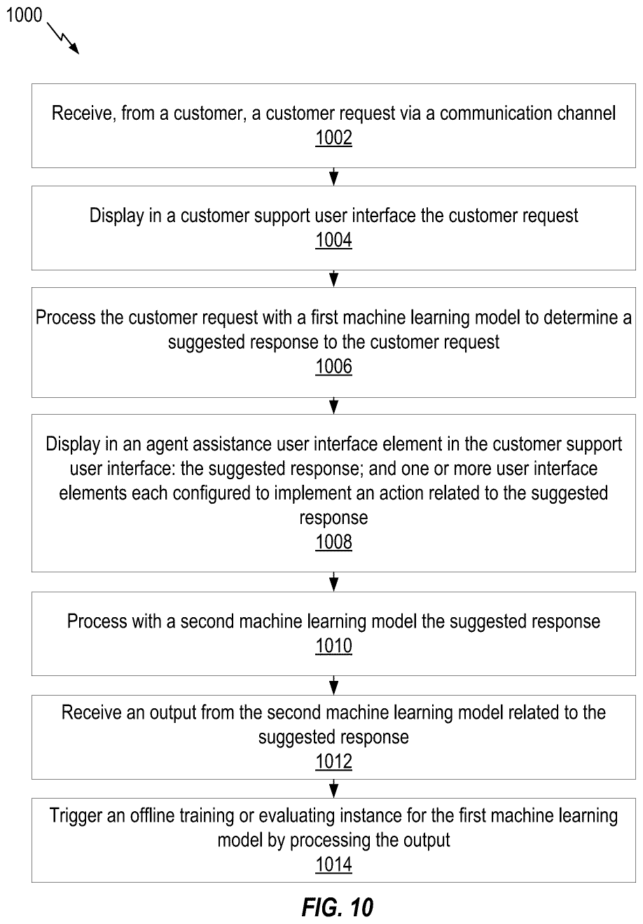

FIG. 10 depicts an example method 1000 of generating suggested responses to customer requests using machine learning models.

Step 1002 includes receiving, from a customer, a customer request via a communication channel (such as, e.g., an email or an online chat as described herein).

Step 1004 includes displaying in a customer support user interface (such as, e.g., the customer support UI 602 described herein with reference to FIG. 6) the customer request.

Step 1006 includes processing the customer request with a first machine learning model to determine a suggested response to the customer request.

Step 1008 includes displaying in an agent assistance user interface element in the customer support user interface (such as, e.g., the agent assistance UI element 606 in the customer support UI 602 described herein with reference to FIG. 6): the suggested response, and one or more user interface elements each configured to implement an action related to the suggested response.

Step 1010 includes processing with a second machine learning model the suggested response.

Step 1012 includes receiving an output from the second machine learning model related to the suggested response.

Step 1014 includes triggering an offline training or evaluating instance for the first machine learning model by processing the received output from the second machine learning model related to the suggested response as a feedback for the first machine learning model.

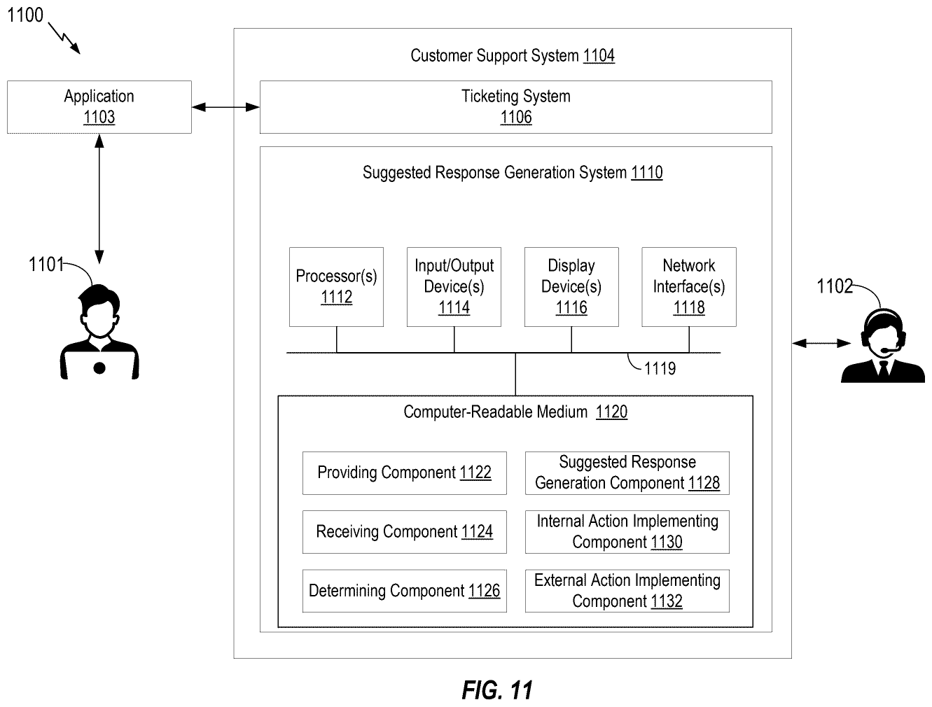

In various aspects, the example methods 800, 900, and 1000 may be performed by one or more processing systems such as, for example, those described herein with reference to FIG. 11 and following the example process flows 200 and/or 700 described herein with reference to, respectively, FIGS. 2 and 7. As described herein, implementing the suggested response based on the approval of a customer support agent beneficially increases the accuracy of the responses provided to the customer requests. For example, the techniques described herein add the extra step of validating the suggested responses generated by the machine learning model. The extra step of validation for the suggested responses provides further technical benefits in providing a checkpoint before an action is taken that may incorrectly change any customer information before, for example, a wrong order is cancelled, a refund is misapplied, a wrong account information is modified, or the like.

### Example Processing Environment

FIG. 11 depicts an example processing environment 1100 in which a system for generating suggested responses to customer requests using machine learning models may be implemented.

Generally, one or more end users 1101 may interact with a customer support system 1104 through, for example, one or more client computer systems. The customer support system 1104, including a ticketing system 1106 and a suggested response generation system 1110, may be provided by an organization, such as a commercial enterprise, to enable the end user 1101 to access a plurality of support services in regards to, for example, a product or service offered by the organization, by an application 1103. Generally, the application 1103 may be any sort of application, such as a web application, native application, mobile device application, smart device application, or the like.

In various aspects, the end user 1101 may utilize the application 1103 to access the customer support system 1104 to provide, for example, a customer support request. In that regard, the application 1103 may provide the means for supporting a communication channel such as, for example, an email or an online chat. In various aspects, the customer support request may be processed by a customer support agent 1102, who interacts with the end user 1101 through the customer support system 1104. In that regard, the application 1103 provides the means for the end user 1101 to interact with the customer support agent 1102 to resolve the customer support request. In some aspects, the application 1103 itself may be available on or through a product to which the customer support request is related, thus providing a direct access to the customer support system 1104 through the application 1103 itself without requiring an additional intermediary tool or method to access the customer support system 1104. In some aspects, the application 1103 may not be associated with the customer support system 1104, but instead may be provided via a device that provides the intermediary means for the end user 1101 to access the customer support system 1104.

The customer support system 1104 may organize the customer support requests using a ticketing system 1106, which generates a ticket to represent each customer support request. The ticketing system 1106 may include a set of software resources that enable the end user 1101 to resolve an issue with the customer support agent 1102. Specific customer support requests may be associated with abstractions called “tickets,” which encapsulate various data and metadata associated with the customer support requests to be resolved. An example ticket may include a ticket identifier and information (or a link to information) associated with the customer support request, as well as other information, in various aspects. For example, information regarding a customer support request may include one or more of: (1) information about the customer support request; (2) end user information for one or more end users who are affected by the customer support request; (3) agent information for one or more customer service agents who are interacting with an end user; (4) email and other electronic communications about the customer support request (which, for example, can include a question posed by an end user); (5) information about telephone calls associated with a problem; (6) timeline information associated with end user interactions to resolve the customer support request, including response times and resolution times, such as a first reply time, a time to full resolution, and a requester wait time; and (7) effort metrics, such as a number of communications or responses by an end user, a number of times a ticket has been re-opened, and a number of times the ticket has been re-assigned to a different customer service agent. It would be apparent to one of ordinary skill in the art that these are just examples, and other information may also be included in the ticket.

In various aspects, the customer support system 1104 further includes the suggested response generation system 1110, which may be configured to perform various methods as described herein, such as those described herein with respect to FIGS. 8-10.

The suggested response generation system 1110 may be implemented in an electronic device configured to execute computer-executable instructions, such as those derived from compiled computer code, including, for example, desktop computers, tablet computers, server computers, cloud-based processing devices, and others.

In the depicted example, the suggested response generation system 1110 includes one or more processors 1112, one or more input/output devices 1114, one or more display devices 1116, one or more network interfaces 1118 through which the suggested response generation system 1110 is connected to one or more networks (e.g., a local network, an intranet, the Internet, or any other group of processing systems communicatively connected to each other), and one or more computer-readable media 1120. In the depicted example, the aforementioned components are coupled by a bus 1119, which may generally be configured for data exchange amongst the components described herein. The bus 1119 may be representative of multiple buses, while only one is depicted for simplicity.

The one or more processors 1112 are generally configured to retrieve and execute instructions stored in one or more memories, including local memories like the computer-readable media 1120, as well as remote memories and data stores. More generally, the bus 1119 may be configured to transmit programming instructions and application data among the processors 1112, the display devices 1116, the network interfaces 1118, and/or the computer-readable media 1120. In certain aspects, the processors 1112 may be representative of one or more central processing units (CPUs), graphics processing units (GPUs), tensor processing units (TPUs), accelerators, and other processing devices.

The input/output devices 1114 may include any device, mechanism, system, interactive display, and/or various other hardware and software components for communicating information between the suggested response generation system 1110 and a user or operator of the suggested response generation system 1110, such as the customer support agent 1102. For example, the input/output devices 1114 may include input hardware, such as a keyboard, touch screen, button, microphone, speaker, and/or other device for receiving inputs from a user and sending outputs to a user.

The display devices 1116 may generally include any sort of device configured to display data, information, graphics, user interface elements, and the like to a user. For example, the display devices 1116 may include internal and external displays such as an internal display of a tablet computer or an external display for a server computer or a projector. The display devices 1116 may further include displays for devices, such as augmented, virtual, and/or extended reality devices. In various aspects, the display devices 1116 may be configured to display a graphical user interface—such as, for example, the customer support UI 602 described herein with reference to FIG. 6.

The network interfaces 1118 provide the suggested response generation system 1110 with access to external networks and thereby to external processing systems. The network interfaces 1118 can generally be any hardware and/or software capable of transmitting and/or receiving data via a wired or wireless network connection. Accordingly, the network interfaces 1118 may include a communication transceiver for sending and/or receiving any wired and/or wireless communication.

The computer-readable media 1120 may be a volatile memory, such as a random access memory (RAM), or a nonvolatile memory, such as nonvolatile random access memory (NVRAM), or the like. In this example, the computer-readable media 1120 include at least a providing component 1122, a receiving component 1124, a determining component 1126, a suggested response generation component 1128, an internal action implementing component 1130, and an external action implementing component 1132.

In certain aspects, the providing component 1122 is configured to perform functions, such as providing inputs to a machine learning model or module. For example, the providing component 1122 may perform the functions of providing the ticket information 202 from the end user 201 to the machine learning model 204 with reference to FIG. 2 or providing the ticket information 702 from the end user 701 to the first machine learning model 704A with reference to FIG. 7. Moreover, the providing component 1122 may perform the functions of providing the prompt information 210 and the action information 212 from the operator 208 to the machine learning model 204 with reference to FIG. 2 or providing the prompt information 710 and the action information 712 from the operator 708 to the first machine learning model 704A with reference to FIG. 7. Furthermore, the providing component 1122 may perform the function of providing the suggested response 706 and the context data 716 to the second machine learning model 704B with reference to FIG. 7.

In certain aspects, the receiving component 1124 is configured to perform functions, such as receiving output from the machine learning model or module. For example, with reference to FIG. 1, the receiving component 1124 may perform, for the suggested response generation system 102, the function of receiving the suggested responses from the machine learning model 110 to provide them to a live customer support agent for approval, editing, or dismissing.

In certain aspects, the determining component 1126 is configured to determine intent or procedure based on ticket information as well as historical data and/or other data as described herein with reference to, for example, step 806 of the method 800 of FIG. 8.

In certain aspects, the suggested response generation component 1128 is configured to perform the suggested response generation, such as via a machine learning model or module, as described herein with respect to, for example, steps 806, 906, and 1006 of, respectively, the methods 800, 900, and 1000 of FIGS. 8-10.

In certain aspects, the internal action implementing component 1130 is configured to execute an internal action executable from within, for example, the suggested response generation system 1110 to perform one or more of the methods disclosed herein to generate suggested responses to customer requests, such as one or more internal actions from the internal actions 402B of FIG. 4 that do not require access to any external system element.

In certain aspects, the external action implementing component 1132 is configured to execute an external action executable via, for example, one of the external APIs 404 to access one of the external systems 406 or external system elements thereof, as described herein with reference to FIG. 4.

FIG. 11 is just one example of a processing environment consistent with aspects described herein, and other processing systems having additional, alternative, or fewer components are possible consistent with this disclosure.

### Example Clauses

Implementation examples are described in the following numbered clauses:

Clause 1: A method, comprising: receiving, from a customer, a customer request via a communication channel; displaying in a customer support user interface the customer request; processing the customer request with a first machine learning model to determine a suggested response to the customer request; and displaying in an agent assistance user interface element in the customer support user interface: the suggested response to the customer request; a first user interface element configured to implement the suggested response; and a second user interface element configured to dismiss or modify the suggested response.

Clause 2: The method in accordance with Clause 1, further comprising: providing a prompt to the first machine learning model, the prompt comprising: first information related to an intended purpose for the first machine learning model; second information related to a format of response to be provided by the first machine learning model; and third information related to one or more rules associated with a response to be provided by the first machine learning model; providing data corresponding to a list of available actions for the first machine learning model to choose from, wherein each available action of the list of available actions comprises one or more parameters related to the each available action; providing the customer request to the first machine learning model; receiving first classification output corresponding to an intent associated with the customer request and second classification output corresponding to a procedure associated with the customer request; and receiving the suggested response to the customer request.

Clause 3: The method in accordance with Clause 2, wherein: at least a first one of the list of available actions comprises an external action that is implemented by an API for an external service, and at least a second one of the list of available actions comprises an internal action that is implemented without an API for an external service.

Clause 4: The method in accordance with any one of Clauses 2-3, wherein the list of available actions comprises at least one of: one or more supervised actions that require an operator approval to be implemented; or one or more safe actions that do not require the operator approval to be implemented.

Clause 5: The method in accordance with any one of Clauses 2-4, wherein: the intent associated with the customer request comprises fourth information related to what the customer is requesting to achieve in the customer request, and the procedure associated with the customer request comprises fifth information related to one or more steps to follow in order to fulfill the customer request.

Clause 6: The method in accordance with Clause 5, further comprising: implementing the one or more steps corresponding to the procedure based on the intent associated with the customer request.

Clause 7: The method in accordance with any one of Clauses 1-6, further comprising: receiving a selection of the first user interface element; and implementing the suggested response by executing at least one of: one or more external actions each implemented by an API for an external service; or one or more internal actions implemented without an API for an external service.

Clause 8: The method in accordance with Clause 7, wherein implementing the suggested response comprises sending a response to the customer request via the communication channel.

Clause 9: The method in accordance with any one of Clauses 7-8, wherein implementing the suggested response comprises taking an action to modify an account associated with the customer.

Clause 10: The method in accordance with any one of Clauses 1-9, further comprising: receiving a selection of the second user interface element; and dismissing the suggested response.

Clause 11: The method in accordance with any one of Clauses 1-10, further comprising: receiving a selection of the second user interface element; and displaying in the customer support user interface an editor user interface element comprising: a third user interface element configured to receive an input to edit the suggested response; a fourth user interface element configured to implement the edited suggested response; and a fifth user interface element configured to cancel editing the suggested response.

Clause 12: The method in accordance with any one of Clauses 1-11, further comprising: receiving an input from an operator comprising a selection of the first user interface element or the second user interface element; and triggering an offline training or evaluating instance for the first machine learning model by processing the received input from the operator as a feedback for the first machine learning model.

Clause 13: The method in accordance with Clause 12, wherein triggering the offline training or evaluating instance for the first machine learning model comprises determining a performance metric associated with the suggested response.

Clause 14: The method in accordance with any one of Clauses 1-13, further comprising: processing with a second machine learning model the suggested response; receiving an output from the second machine learning model related to the suggested response; and triggering an offline training or evaluating instance for the first machine learning model by processing the received output from the second machine learning model related to the suggested response as a feedback for the first machine learning model.

Clause 15: The method in accordance with any one of Clauses 1-14, further comprising: receiving in an inquiry user interface element in the customer support user interface an inquiry from an operator; processing the inquiry from the operator with the first machine learning model to determine a response; and displaying in the customer support user interface the response from the first machine learning model.

Clause 16: A processing system, comprising: a memory comprising computer-executable instructions; and a processor configured to execute the computer-executable instructions and cause the processing system to perform a method in accordance with any one of Clauses 1-15.

Clause 17: A processing system, comprising means for performing a method in accordance with any one of Clauses 1-15.

Clause 18: A non-transitory computer-readable medium comprising computer-executable instructions that, when executed by a processor of a processing system, cause the processing system to perform a method in accordance with any one of Clauses 1-15.

Clause 19: A computer program product embodied on a computer-readable storage medium comprising code for performing a method in accordance with any one of Clauses 1-15.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
receiving, from a customer, a customer request via a communication channel;
displaying in a customer support user interface the customer request;
processing the customer request with a first machine learning model to determine a suggested response to the customer request; and
displaying in an agent assistance user interface element in the customer support user interface:
the suggested response to the customer request;
a first user interface element configured to implement the suggested response; and
a second user interface element configured to dismiss or modify the suggested response.

2. The method of claim 1, wherein processing the customer request with the first machine learning model to determine the suggested response to the customer request comprises:
providing a prompt to the first machine learning model, the prompt comprising:
first information related to an intended purpose for the first machine learning model;
second information related to a format of response to be provided by the first machine learning model; and
third information related to one or more rules associated with a response to be provided by the first machine learning model;
providing data corresponding to a list of available actions for the first machine learning model to choose from, wherein each available action of the list of available actions comprises one or more parameters related to each available action;
providing the customer request to the first machine learning model;
receiving first classification output corresponding to an intent associated with the customer request and second classification output corresponding to a procedure associated with the customer request; and
receiving the suggested response to the customer request.

3. The method of claim 2, wherein:
at least a first one of the list of available actions comprises an external action that is implemented by an Application Programming Interface (API) for an external service, and
at least a second one of the list of available actions comprises an internal action that is implemented without an API for an external service.

4. The method of claim 2, wherein the list of available actions comprises at least one of:
one or more supervised actions that require an operator approval to be implemented; or
one or more safe actions that do not require the operator approval to be implemented.

5. The method of claim 2, wherein:
the intent associated with the customer request comprises fourth information related to what the customer is requesting to achieve in the customer request, and
the procedure associated with the customer request comprises fifth information related to one or more steps to follow in order to fulfill the customer request.

6. The method of claim 5, further comprising:
implementing the one or more steps corresponding to the procedure based on the intent associated with the customer request.

7. The method of claim 1, further comprising:
receiving a selection of the first user interface element; and
implementing the suggested response by executing at least one of:
one or more external actions each implemented by an Application Programming Interface (API) for an external service; or
one or more internal actions implemented without an API for an external service.

8. The method of claim 7, wherein implementing the suggested response comprises sending a response to the customer request via the communication channel.

9. The method of claim 7, wherein implementing the suggested response comprises taking an action to modify an account associated with the customer.

10. The method of claim 1, further comprising:
receiving a selection of the second user interface element; and
dismissing the suggested response.

11. The method of claim 1, further comprising:
receiving a selection of the second user interface element; and
displaying in the customer support user interface an editor user interface element comprising:
a third user interface element configured to receive an input to edit the suggested response;
a fourth user interface element configured to implement the edited suggested response; and
a fifth user interface element configured to cancel editing the suggested response.

12. The method of claim 1, further comprising:
receiving an input from an operator comprising a selection of the first user interface element or the second user interface element; and
triggering an offline training or evaluating instance for the first machine learning model by processing the received input from the operator as a feedback for the first machine learning model.

13. The method of claim 12, wherein triggering the offline training or evaluating instance for the first machine learning model comprises determining a performance metric associated with the suggested response.

14. The method of claim 1, further comprising:
processing with a second machine learning model the suggested response;
receiving an output from the second machine learning model related to the suggested response; and
triggering an offline training or evaluating instance for the first machine learning model by processing the received output from the second machine learning model related to the suggested response as a feedback for the first machine learning model.

15. The method of claim 1, further comprising:
receiving in an inquiry user interface element in the customer support user interface an inquiry from an operator;
processing the inquiry from the operator with the first machine learning model to determine a response; and
displaying in the customer support user interface the response from the first machine learning model.

16. A processing system, comprising: one or more memories comprising computer-executable instructions; and one or more processors, coupled to the one or more memories, configured to execute the computer-executable instructions and cause the processing system to:
receive, from a customer, a customer request via a communication channel;
display in a customer support user interface the customer request;
process the customer request with a first machine learning model to determine a suggested response to the customer request; and
display in an agent assistance user interface element in the customer support user interface:
the suggested response to the customer request;
a first user interface element configured to implement the suggested response; and
a second user interface element configured to dismiss or modify the suggested response.

17. The processing system of claim 16, wherein to process the customer request with the first machine learning model to determine the suggested response to the customer request comprises:
to provide a prompt to the first machine learning model, the prompt comprising:
first information related to an intended purpose for the first machine learning model;
second information related to a format of response to be provided by the first machine learning model; and
third information related to one or more rules associated with a response to be provided by the first machine learning model;
to provide data corresponding to a list of available actions for the first machine learning model to choose from, wherein each available action of the list of available actions comprises one or more parameters related to each available action;
to provide the customer request to the first machine learning model;
to receive first classification output corresponding to an intent associated with the customer request and second classification output corresponding to a procedure associated with the customer request; and
to receive the suggested response to the customer request.

18. The processing system of claim 17, wherein:
at least a first one of the list of available actions comprises an external action that is implemented by an Application Programming Interface (API) for an external service, and
at least a second one of the list of available actions comprises an internal action that is implemented without an API for an external service.

19. The processing system of claim 17, wherein the list of available actions comprises at least one of:
one or more supervised actions that require an operator approval to be implemented; or
one or more safe actions that do not require the operator approval to be implemented.

20. The processing system of claim 16, wherein the one or more processors are further configured to cause the processing system to:
process with a second machine learning model the suggested response;
receive an output from the second machine learning model related to the suggested response; and
trigger an offline training or evaluating instance for the first machine learning model by processing the received output from the second machine learning model related to the suggested response as a feedback for the first machine learning model.
